(19) United States
(12) Patent Application Publication
(10) Pub. No.: US 2025/0273846 A1
(43) Pub. Date: Aug. 28, 2025

(54) Parasitic Slots for Antenna Enhancement

(71) Applicant: Google LLC, Mountain View, CA (US)

(72) Inventors: Yun-Ying Chan, New Taipei City (TW); Cheng-Jung Lee, San Jose, CA (US); Chia-cheng Lin, New Taipei City (TW); Cheng-Han Lee, New Taipei City (TW); Huanyu Chen, Fremont, CA (US); Peter Bevelacqua, Sunnyvale, CA (US); Josh Tu, Sunnyvale, CA (US); Mitchell Hoertz, San Francisco, CA (US); Brian Huynh, San Jose, CA (US)

(73) Assignee: Google LLC, Mountain View, CA (US)

(21) Appl. No.: 18/587,458

(22) Filed: Feb. 26, 2024

(51) Int. Cl. H01Q 1/22; H01Q 1/48; H01Q 13/10

(52) U.S. Cl. CPC H01Q 1/2291; H01Q 1/48; H01Q 13/10

(57) ABSTRACT

Various arrangements for including a parasitic slot are described herein. A wireless fidelity (WIFI) slot antenna is mounted within a first area of an electronic device that includes a metal enclosure, wherein the antenna includes a primary slot. A parasitic slot is formed within a second area of the electronic device, wherein the parasitic slot is positioned within the second area and has a size configured to increase an efficiency of a frequency range of the WIFI slot antenna.

### BACKGROUND

Electronic devices, such as tablet computing devices and mobile phones, include one or more antennas for use in wireless communication. For example, the electronic devices may include functionality to communicate using one or more WiFi bands (e.g., 2.4 GHz, 5 GHz). It can be difficult, however, to incorporate antennas in today's electronic devices. Many electronic devices have metal structures with limited space to place the antennas. Further, degradation of the performance and efficiency of the antennas may result from proximity of the antennas to certain components (e.g., battery, metal plate), which can interfere with the electric signals on the antennas. Still yet, some electronic devices may have full metal enclosures, without an antenna window, that can significantly degrade antenna signals.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a view of an electronic device that includes a metal enclosure for a slot antenna.

FIG. 2 illustrates a view of an electronic device that includes a metal enclosure for a slot antenna and a parasitic slot.

FIG. 3 illustrates a comparison of a slot antenna that includes a parasitic slot and a slot antenna that does not include a use of a parasitic slot.

FIG. 4 illustrates a view of an electronic device that has a narrow bezel.

FIG. 5 illustrates an embodiment of a method that includes a parasitic slot to increase the efficiency of a slot antenna.

FIG. 6 shows some components of an electronic computing device, such as a tablet.

### DETAILED DESCRIPTION

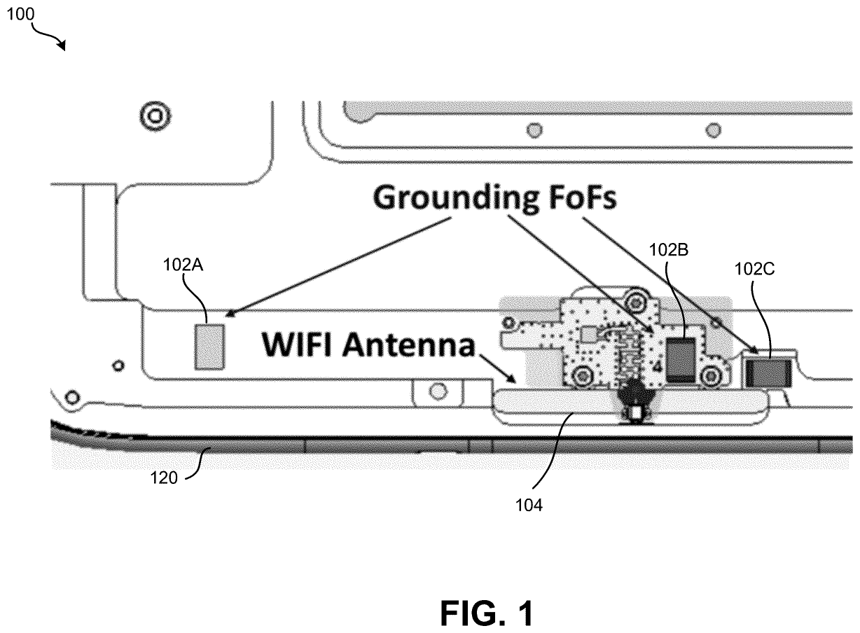

FIG. 1 illustrates a top view 100 of a portion of an electronic device 120 that includes a slot antenna 104. In some examples, the electronic device 120 may be a tablet computing device, or some other mobile computing device that includes one or more antennas, such as a slot antenna 104. According to some configurations, the electronic device 120 has a full metal enclosure that does not include an antenna window. In the current example, the slot antenna 104 is a wireless fidelity (WIFI) antenna that emits radiation from the enclosure. In some examples, the electronic device 120 does not include an antenna window.

As illustrated, the slot antenna 104 is a WiFi antenna that can operate at one or more bands (e.g., 2.4 GHz, 5 GHz, 6 GHz bands). While one antenna is illustrated, more or fewer antennas may be included in other examples. Further, the antennas may be configured to operate at different bands.

Slot antennas usually include grounding to floating metals at different grounding positions to improve antenna efficiencies. Generally, conductive fabric over foams (FoF), spring contacts, or screws are expected to be put near the antenna, or even surrounding the whole antenna, to ensure FoFs and springs provide efficient grounding conditions.

Using either FoFs, springs, or screws, however, requires sufficient space and height within the device 120. In addition, even with sufficient area, a bigger area for FoF grounding increases the force which pushes the display module away from the enclosure, raising structural risks. In some cases, to prevent force pushing ICs and to limit the force FoFs push display module, one or more grounding FoFs may be limited in size and placed farther away from the slot antenna 104 than desired. Since one or more the grounding FoFs may be farther away from the slot antenna 104 to restrict the current in a certain area, the energy from the slot antennal 104 goes to other directions in the enclosure rather than radiating into the air, and eventually reducing the efficiency of the WIFI slot antenna 104.

As discussed, grounding positions and placement of the FoFs can be restricted due to different components that are included within the electronic device. In the example illustrated in FIG. 1, three grounding positions 102A, 102B, and 102C are illustrated. As can be seen, at least one of the grounding positions 102A for the WIFI antenna 104 cannot be placed near the antenna itself because of the presence of other componentry (e.g., display driver ICs not shown). As discussed briefly above, in the situation when grounding is too far from the antenna, such as slot antenna 104, to properly restrict the current in a certain area of the device 120, the energy from slot antenna 104 goes to other directions in the enclosure rather than radiating into the air and reduces the efficiency of the antenna.

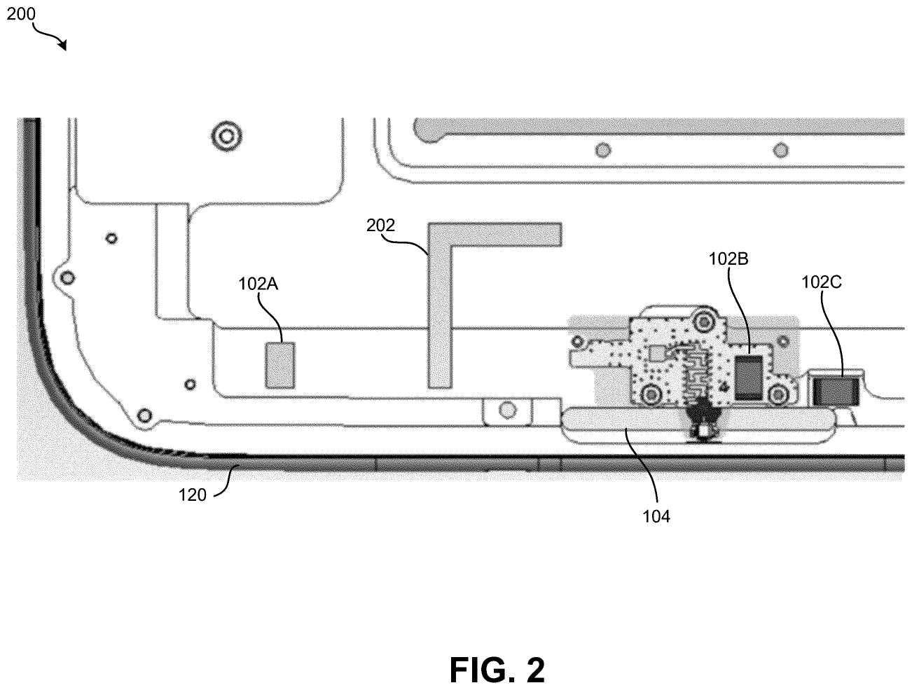

FIG. 2 illustrates a top view 200 of a portion of an electronic device 120 that includes a slot antenna 104 and a parasitic slot 202. As discussed above, the electronic device 120 may be a tablet computing device, or some other mobile computing device that includes one or more antennas, such as a WIFI slot antenna 104 that is enclosed within a metal enclosure that does not include an antenna window.

As illustrated, the slot antenna 104 is a WiFi antenna that can operate at one or more bands (e.g., 2.4 GHz, 5 GHz, 6 GHz bands). While one antenna is illustrated, more or fewer antennas may be included in other examples. Further, the antennas may be configured to operate at different bands. For purposes of explanation, the antenna 104 is configured to be efficient between about 5-7 GHz.

To increase the efficiency of antenna 104 near the 5 GHz frequency, a parasitic slot 202 is positioned, and sized within device 120. The parasitic slot 202 may also increase the directivity of the antenna such that the energy is focused in a given direction. In some examples, the slot is a conductive slot having a length, width, and depth that is created within the device 120. Generally, the size (e.g., length, width, depth) of the parasitic slot 202 determines the radiation of frequency that is enhanced. In the current example, the frequency improvement is targeted to be near the 5 GHz frequency. The parasitic slot 202 can be formed by a CNC pass to remove a portion of the enclosure to create the parasitic slot. In some examples, the parasitic slot 202 can be covered (e.g., by a plastic material, or some other material). In some examples, the parasitic slot 202 does not have a clip feeding from cable.

The parasitic slot 202 can be any shape. For example, instead of the parasitic slot 202 being a L shape, the parasitic slot 202 could be straight, a curve, or in some other shape. In some examples, there could be other parasitic slots included within the enclosure. The parasitic slot 202 could also be in a different location within the enclosure. For example, parasitic slot 202 could be located on the other side of antenna 104 (e.g., near grounding location 102C), or at some other location. Generally, the parasitic slot 202 is placed in a location in which available space within the enclosure and near the antenna 104. Testing, or simulation, can be used to determine locations of the parasitic slot 202 within the enclosure to increase the efficiency of the antenna 104 at one or more frequencies.

To enhance the efficiency of the WIFI antenna, an additional slot, parasitic slot 202, is placed within the enclosure between the WIFI slot antenna 104 and grounding FoF 102A to increase the efficiency of slot antenna 104. As illustrated, the parasitic slot 202 does not have a clip feeding from cable. It is found that if this parasitic slot is added at a proper position and with proper length, some energy going away from the origin antenna could be radiated. Therefore, the overall efficiency could be improved.

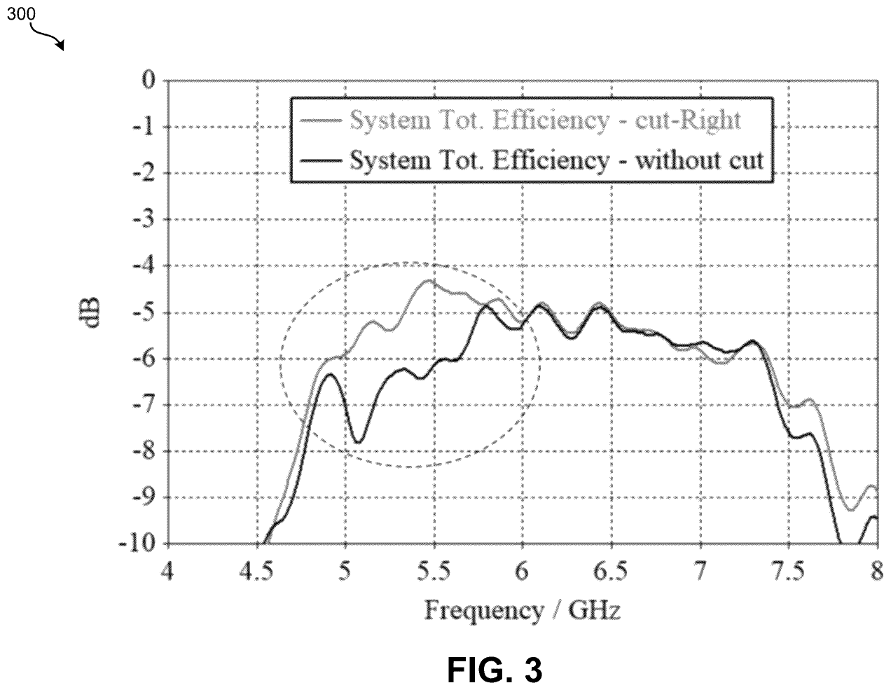

By adjusting the overall length of the parasitic slot properly, the efficiency at 5-5.5 GHz can be improved, as shown in FIG. 3. It is found that the overall length L of the parasitic slot is around half-wavelength of the desired frequency to improve. Alternative embodiments including bending or meandering the parasitic slot are also effective. After bending or meandering, the actual length of the parasitic slot 202 may be a little different, since the electrical current and field are more complex at the bending area.

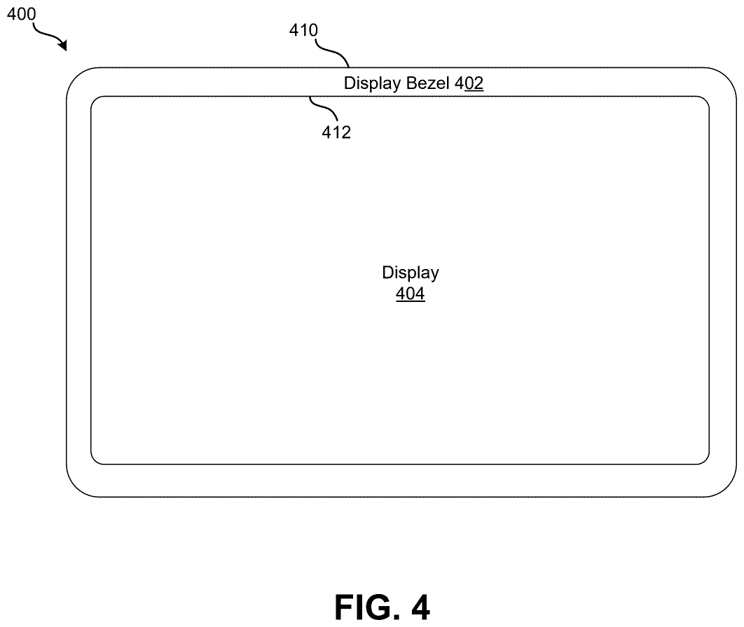

FIG. 4 illustrates a top view 400 of an electronic device that has a narrow display bezel 402. As illustrated, an electronic device, such as a tablet computing device, has a display bezel 402 that surrounds the display 404. In the current example, the display bezel is a narrow width that is defined by outside line 410 and inside line 412 (e.g., less than 10 mm, 12 mm, . . . ). According to some configurations, the display 404 may be disposed on top of a full metal enclosure that does not include an antenna window. As discussed above, the performance and efficiency of antennas can be degraded from proximity of the antennas to certain components (e.g., battery, metal plate), which can interfere with the electric signals on the antennas.

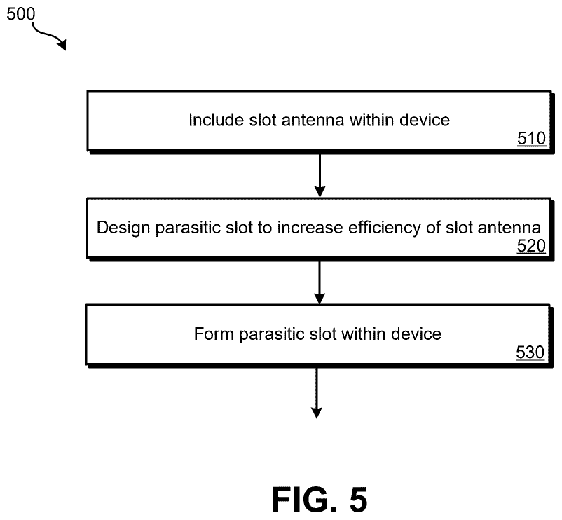

Various methods may be performed using the systems, states, and arrangements detailed in relation to FIGS. 1-4. FIG. 5 illustrates a method that may be performed to include a parasitic slot 202 to increase the efficiency of a slot antenna 104.

At block 510, a slot antenna is included within a device. In some examples, the electronic device 120 has a full metal enclosure that does not include an antenna window. The slot antenna 104 is configured to emit radiation from the enclosure. In some examples, the slot antenna 104 is a WIFI antenna that can operate at one or more bands (e.g., 2.4 GHz, 5 GHz, 6 GHz bands).

At block 520, a parasitic slot 202 is designed to increase the efficiency of a slot antenna 104. As discussed above, in order to increase the efficiency of antenna 104 (e.g., near the 5 GHz frequency), a parasitic slot 202 is included within device 120. In some examples, the slot is a conductive slot having a length, width, and depth that is created within the device 120. Generally, the size (e.g., length, width, depth) of the parasitic slot 202 determines the radiation of frequency that is enhanced. The parasitic slot 202 can be any shape. For example, instead of the parasitic slot 202 being a L shape, the parasitic slot 202 could be straight, a curve, or in some other shape. In some examples, the parasitic slot 202 is also positioned and/or sized to increase the directionality of the slot antenna 104.

At block 503, the parasitic slot is included within the device. Generally, the parasitic slot 202 is placed near the primary slot of the slot antenna 104.

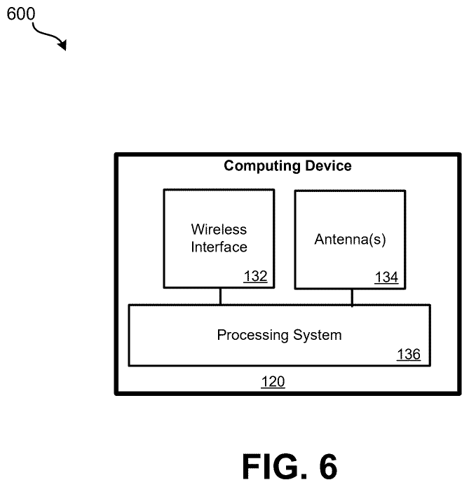

FIG. 6 shows some components of an electronic computing device 120, such as a tablet. Specifically, device 120 include: wireless interfaces 132; antenna(s) 134, and processing system 136. As illustrated in different drawings, the device 130 may have many other components, such as but not limited to microphones, speakers, a full metal enclosure, a display, a bezel, and the like.

Computing device 120 includes wireless interface 132 and processing system 136. Examples of computing device 120 can include: a smartphone; a desktop, laptop, or tablet computer; a gaming device; a smart television; a digital music player device; a smartwatch; smart glasses; an augmented reality or a virtual reality headset; or any other device. Computing device 120 includes wireless interface 132, which can wirelessly communicate with other devices, using one or more types of communication protocols.

Processing system 136 may include one or more special-purpose or general-purpose processors. Such special-purpose processors may include processors that are specifically designed to perform the functions of the components detailed herein, such as detailed in relation to processing systems 126.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A device, comprising:
a wireless fidelity (WIFI) slot antenna mounted within a first area of an electronic device that includes a metal enclosure, wherein the antenna includes a primary slot;
a plurality of fabric over foams (FoFs) mounted at different locations within the electronic device, wherein the plurality of FoFs are configured to provide grounding for the WIFI slot antenna; and
a parasitic slot formed within a second area of the electronic device, wherein the parasitic slot is positioned within the second area and has a size configured to increase an efficiency of a frequency range of the WIFI slot antenna.

2. The device of claim 1, further comprising a second parasitic slot that is formed within a third area of the electronic device.

3. The device of claim 1, wherein the parasitic slot is an L-shape.

4. The device of claim 1, wherein the parasitic slot is formed by removing a portion of the metal enclosure.

5. The device of claim 1, wherein the parasitic slot is formed from one or more of can copper, aluminum, or stainless steel.

6. The device of claim 1, wherein the size of the parasitic slot is based on the frequency range of the WIFI slot antenna.

7. The device of claim 1, wherein the plurality of FoFs include at least three FoFs.

8. The device of claim 1, wherein a location of parasitic slot within the second area is based at least in part on a directivity of the WIFI antenna.

9. A system, comprising:
an electronic device that includes a metal enclosure;
a wireless fidelity (WIFI) slot antenna mounted within a first area of the electronic device, wherein the antenna includes a primary slot;
a plurality of fabric over foams (FoFs) mounted at different locations within the electronic device, wherein the plurality of FoFs are configured to provide grounding for the WIFI slot antenna; and
a parasitic slot formed within a second area of the electronic device, wherein the parasitic slot is positioned within the second area and has a size configured to increase an efficiency of a frequency range of the WIFI slot antenna.

10. The system of claim 9, further comprising a second parasitic slot that is formed within a third area of the electronic device.

11. The system of claim 9, wherein the parasitic slot is an L-shape.

12. The system of claim 9, wherein the parasitic slot is formed by removing a portion of the metal enclosure.

13. The system of claim 9, wherein the parasitic slot is formed from one or more of can copper, aluminum, or stainless steel.

14. The system of claim 9, wherein the size of the parasitic slot is based on the frequency range of the WIFI slot antenna.

15. The system of claim 9, wherein the plurality of FoFs include at least three FoFs.

16. The system of claim 9, wherein a location of parasitic slot within the second area is based at least in part on a directivity of the WIFI antenna.

17. A device, comprising:
a wireless fidelity (WIFI) slot antenna mounted within a first area of an electronic device that includes a metal enclosure, wherein the antenna includes a primary slot;
at least three fabric over foams (FoFs) mounted at different locations within the electronic device, wherein the at least three FoFs are configured to provide grounding for the WIFI slot antenna; and
a parasitic slot formed within a second area of the electronic device, wherein the parasitic slot is positioned within the second area and sized to increase an efficiency of a frequency range of the WIFI slot antenna.

18. The device of claim 17, further comprising a second parasitic slot that is formed within a third area of the electronic device.

19. The device of claim 17, wherein the parasitic slot is an L-shape.

20. The device of claim 1, wherein the parasitic slot is formed by removing a portion of the metal enclosure.
